(19) United States
(12) Patent Application Publication
(10) Pub. No.: US 2026/0064110 A1
(43) Pub. Date: Mar. 5, 2026

(54) METHOD AND DEVICE FOR CONTROLLING INTELLIGENT DEVICES, INTELLIGENT TECHNICAL SYSTEMS, ROBOTS OR THE LIKE, AND INTELLIGENT DEVICE, INTELLIGENT TECHNICAL SYSTEM, ROBOT OR THE LIKE WHICH IS CONTROLLABLE BY SUCH A METHOD AND/OR HAS SUCH A DEVICE

(71) Applicant: Benjamin Salko Nitzinger, Anger (DE)

(72) Inventor: Benjamin Salko Nitzinger, Anger (DE)

(21) Appl. No.: 19/280,171

(22) Filed: Jul. 25, 2025

(30) Foreign Application Priority Data
Sep. 3, 2024 (DE) 1020240028390

(51) Int. Cl. G05B 23/02

(52) U.S. Cl. CPC G05B 23/0286; G05B 23/024; G05B 23/0264

(57) ABSTRACT

The present invention relates to a device and a method for controlling intelligent devices, intelligent technical systems, robots or the like as well as a intelligent device, intelligent technical system, robot or the like, which has such a device and/or can be controlled by such a method comprising a computer-implemented method and a device enabled by a AI small as well as large language model. The computer-implemented method generates control commands and includes verification steps to reduce negative effects and the control risk by modifying the control command, due to a possibly incorrect control, using deep neural networks comprising an AI language model executed at least on an artificial intelligence computing unit.

### CROSS-REFERENCE TO RELATED APPLICATIONS

This application claims priority to German Patent Application No. 10 2024 002839.0, filed on Sep. 3, 2024, the entire contents of which are incorporated herein by reference.

### FIELD

The present invention relates to a device and a method for controlling intelligent devices, intelligent technical systems, robots or the like. Furthermore, the invention relates to an intelligent device, intelligent technical system, robot or the like, which has such a device and/or can be controlled by such a method.

### BACKGROUND OF THE INVENTION

Small and large language models (LLMs) of artificial intelligence (AI) can be used to control external devices, technical systems, and robots by generating control commands. However, conventional implementations require, among other factors, substantial system resources to ensure safe and reliable operation. The present disclosure addresses these problems and solutions while reducing the system requirements for safe and reliable control.

### SUMMARY OF THE INVENTION

The present disclosure relates to AI language model based control of intelligent devices, intelligent technical systems or robots to reduce risks. Conventional methods require separate large language models and enterprise like high-performance hardware to operate safe and reliable. The disclosed methods reduce risks from faulty control while reducing the technical system requirements. Control commands are evaluated for risk and only executed if acceptable. Continuous device data is provided, eliminating the need for middleware. The disclosed device avoids delays and computing time for communication with a separately operated AI language model, for example the encryption-related processing of communication over networks.

### BRIEF DESCRIPTION OF DRAWINGS

FIG. 1 is a flow diagram of an example method relating to controlling intelligent technical systems and/or intelligent devices and/or robots or the like by means of an AI language model.

FIG. 2 is a flow diagram of an example method relating to controlling intelligent technical systems and/or intelligent devices and/or robots or the like by means of an AI language model with combined steps.

FIG. 3 is a block diagram illustrating a device to control an intelligent device.

FIG. 4 is a block diagram illustrating a device to control an intelligent technical system.

FIG. 5 is a block diagram illustrating a device to control a robot.

FIG. 6 is a block diagram illustrating a device to control an intelligent device, an intelligent technical system, and a robot.

### DETAILED DESCRIPTION OF THE INVENTION

Artificial intelligence (AI) language models can, for example, process texts and generate new texts. Although AI language models cannot control directly, they can, for example, generate control commands that can be used for control. To control an intelligent technical system, intelligent device, robot or the like using an AI language model, a control command generated by the AI language model must be transferred to a control unit, for example. In some current methods, manual activities by a user and/or further steps are necessary, such as converting the generated source code into machine code.

To address this problem, computer-implemented methods have been developed that generate a control command using an AI language model and make it available to another computer, an intelligent device, an intelligent technical system or the like for control.

Large language models (for short LLMs) are used in some current methods for controlling intelligent technical systems, intelligent devices and the like. The use of LLMs helps to increase the reliability of the generation of control commands in order to minimise the effects of any control errors. However, a significant disadvantage of LLM is the considerable technical system requirements. According to the current state of the art, the operation of an LLM requires specialised, high-performance computer systems, preferably equipped with several computing units for artificial intelligence, whereby the energy consumption is high and/or operation preferably takes place in data centres. For this reason, an LLM is currently operated separately from the control unit, an intelligent device, an intelligent technical system or the like. Such separate operation requires additional communication steps, for example to provide the outputs of a remote LLM via a network or the Internet, possibly using middleware, an intelligent device, an intelligent technical system or the like. Some methods, such as the quantisation of language models, can only reduce the technical requirements for the use of large language models (LLMs) to a limited extent.

Operating the LLM separately increases the likelihood of errors, negative effects and risks, such as problems with data provision, stability, latency, delays, failed file provision and control risks. Furthermore, security measures require additional computing resources and computing time, e.g. for cryptographic procedures to secure communication. The negative effects of any incorrect control of intelligent devices, technical systems or robots can cause considerable damage, including damage to life and limb or the environment.

A current method for providing data and functions for an LLM uses function calling, English “Function Calling”. “Function calling” can be understood as a request-based provision of information or request-based function call during the execution of a controller. This increases the communication steps, prolonging the overall control process and increasing risks. Function calling can only be implemented to a limited extent with SLM because, for example, only low success and recognition rates are achieved without special training of the SLM for specific purposes.

Although SLMs have lower technical system requirements, the smaller size of the deep neural network, for example, increases the risks and negative effects of possibly incorrect, false, incomplete, unintended or only partial control compared to LLMs. LLM and especially current SLM can generate incorrect results despite correct input data, or produce different outputs with identical input data.

Current methods for controlling technical systems with the help of artificial intelligence relate to an industrial environment and/or to the control of non-intelligent technical systems and/or are aimed at the time-critical execution of a control system or the achievement of a processing time by adapting a control application.

A disclosed method or device for controlling intelligent devices, intelligent technical systems, robots or the like with an SLM, which is comparable to the method according to the invention, has not been discovered.

It is therefore a task of the invention to develop a method, a device and a control system for controlling intelligent technical systems, intelligent devices, robots or the like, comprising the following tasks:
enabling the methods according to the invention and/or the device according to the invention to be carried out with an SLM, in particular without the need for specialised, high-performance computers,
avoiding separate operation of the AI language model by integrating the methods and device in a control system comprising a control interface and a computing unit for artificial intelligence,
minimise the negative effects of possibly faulty, incorrect, incomplete, unintentional or only partial control, especially when using an SLM,
faster control decisions and control processes, as data is provided continuously,
A significant advantage of the methods according to the invention and the device according to the invention is that they can be implemented on standard commercial or household computers and computing units for artificial intelligence (AI). This means that no specialised, high-performance computers, such as those used in data centres, are required. This enables implementation in compact housings on a wide range of common computers and systems, which both reduces costs and increases the accessibility of the technology.

A further significant advantage of the method and the device according to the invention is that the use of LLM can be dispensed with in order to minimise the risks and effects of possibly faulty, incorrect, incomplete, unintentional or only partial control. This is achieved, for example, by determining a control risk as a function of, for example, the device and input data ED1, a comparison of the determined control risk value with a maximum control risk value D, generation of the control commands with execution-protecting features, continuous data provision and context parameters, for example, a control risk context SK1, a control and data specification SP1, an action instruction H. The method according to the invention and the device according to the invention verifies before controlling whether an acceptable level of control risk has been reached, rejects control or reduces the control risk by modifying the control command, whereby control only takes place if a predetermined maximum control risk value (D) is complied with, in order to minimise the negative effects of any faulty, incorrect, incomplete, unintentional or only partial control.

To further minimise the negative effects of any faulty, incorrect, incomplete, unintentional or only partial control, control commands are generated in the process with execution-protecting features, which are only removed after a verification, for example depending on the input data, which also includes device data.

A further significant advantage of the methods and the device according to the invention is that device data or input data is provided continuously, so that middleware and request-based provision of data or functions, for example using function calling, is no longer necessary. The continuous provision of device data or input data means that decisions on control processes can be made directly and/or comprehensively.

A further significant advantage of the method and the device according to the invention is that separate operation of the AI language model is avoided and the associated risks in communication via a network between a system that executes the AI language model and a middleware, control unit, intelligent device, intelligent technical system, robot or the like are reduced. The associated calculation times, for example for encryption and decryption, are also avoided.

Examples of embodiments of the method according to the invention, the device according to the invention and the control system according to the invention are shown by way of example in the drawings and are explained in more detail in the following description.

In particular, the following embodiment examples merely show exemplary implementation possibilities, in particular how such implementations of the methods according to the invention and the device according to the invention and the control system according to the invention could look, since it is impossible to describe or draw all these implementation possibilities. It is also not expedient or necessary for an understanding of the invention.

In this description, ‘large AI language models’, ‘Large Language Model’ (abbreviated to ‘LLM’) is used to describe an artificial intelligence with deep neural networks that is specialised in natural language processing, in English Natural Language Processing (for short NLP), and/or text processing. It is typically trained with very extensive training data (text corpora) and preferably has at least 8 billion parameters to recognise and model patterns in the language and/or text. LLM can include transformers, in English transformer, or transformer models that are able to process text data at scale.

In this description, ‘small AI language models’ and ‘small language model’ (SLM for short) are used to describe an artificial intelligence with deep neural networks that is specialised in natural language processing, English Natural Language Processing (NLP for short), and/or text processing. It is typically trained using extensive training data (text corpora) and has up to 8 billion parameters to recognise and model patterns in speech and/or text. LLM can include transformers, in English transformer, or transformer models that are able to process text data at scale.

In this description, ‘middleware’ is used to describe a combination of hardware and software that mediates between different computers, systems or components. It provides basic functions and services that enable communication, integration and interoperability between different systems or applications. Middleware can include protocol conversion, data format conversion, message switching, authentication, transaction management and other supporting services to facilitate and coordinate the interaction and co-operation of software modules.

In particular, a ‘processor’ can be a main processor, in English also known as a central processing unit (CPU for short). A processor can also be a virtual processor. For example, it can also be a programmable processor which is set up in such a way that it implements the methods, modules or other aspects and/or sub-aspects of the invention according to the invention. A processor can also be a virtualised processor, for example a virtualised network of several processors. It can also be a physical network of several processors.

The term ‘communication interface’ can be understood as a combination of hardware and/or software intended for data exchange, whereby data can be exchanged, for example, via physical, optical or wireless communication, e.g. a USB interface, a fibre optic connection, a LAN connection, an energy-saving long-range radio, short-range radio, low-energy radio, Bluetooth Low Energy, LPWAN technology, cordless communication, energy-saving cordless communication, short-range radio, wireless mesh network for home automation, wireless LAN or wireless network, Ethernet, communication protocol for energy management, powerline communication technology, KNX, serial peripheral interfaces, CAN bus, communication radio, industrial bus, IP-based home automation system radio, or a potential-free contact. In some embodiments, it may include a computer programme product, for example a driver.

In the context of the invention, ‘providing’ can be understood to mean, for example, computer-aided provision. This applies in particular with regard to data and/or information. The provisioning takes place, for example, via a communication interface. For example, data or information can be transmitted and/or sent and/or retrieved and/or received via such an interface during provision.

An ‘intelligent device’ refers, for example, to an electronic device comprising at least one communication interface, at least one sensor and at least one actuator, which is able to perform at least one specific function in order to fulfil at least one specific task autonomously or semi-autonomously. ‘Intelligent devices’ can be, for example, intelligent or in English known as smart household appliances, wearables, displays, touchscreens, hubs, loudspeakers, household robots, pool cleaners, body scales, doorbells, heating or radiator thermostats, security cameras, air conditioning units, roller shutters, alarm devices, gripper arms, robots, trolleys, pet food stations and garage doors.

An ‘intelligent technical system’ means, for example, at least one central control or regulation unit for intelligent or non-intelligent devices, which is able to fulfil even complex tasks autonomously or semi-autonomously by exchanging data, regulating and/or controlling at least one intelligent or non-intelligent device, comprising at least one communication interface and at least one intelligent or non-intelligent device which communicates with this central control or regulation unit. ‘Intelligent technical systems’ can be, for example, smart home systems, smart home hubs with intelligent devices, unmanned aerial systems, building automation systems, air purification systems, robots, robotic systems, heating systems, cooling systems, alarm and/or security systems, water supply systems, lighting systems, parking systems or control or regulation units with intelligent devices.

A ‘control risk’ refers to a risk, for example, in relation to correct, incorrect, partially or incompletely executed controls. It is a combined assessment of the probability of occurrence of a damaging event and possible damage caused by the execution of at least one control system. It can, for example, include risks to the controlled device, life and limb or the environment. An assessment of the damage can also include, for example, the consequences of damage.

In the context of the invention, ‘control risk value’ can be understood to mean, for example, a value or parameter that indicates a control risk. In some embodiments, this value or parameter may, for example, be a number. In some embodiments, this value or parameter may be, for example, a combination of numeric and alphanumeric characters.

In the context of the invention, a ‘maximum control risk value’ can be understood to mean, for example, a parameter that specifies the maximum accepted control risk. In some embodiments, this value or parameter may be a number. In some embodiments, this value or parameter may be, for example, a combination of numeric and alphanumeric characters.

Unless otherwise stated in the following description, the terms ‘execute’, ‘calculate’, ‘generate’, ‘compute’, ‘determine’ and the like preferably refer to actions and/or processes and/or processing steps that modify and/or generate data and/or convert data into other data.

The term ‘computer’ should be understood and interpreted as broadly as possible, in particular to include all electronic devices with data processing capabilities. Computers can be, for example, personal computers (PC for short), notebooks, laptops, servers, handheld computers, pocket PCs, embedded computers, single-board computers, tablets, smartphones, mainframes, virtual computers, clusters, rigs, supercomputers, quantum computers and other devices that can process computerised data.

A ‘computing unit for artificial intelligence’ can be understood, for example, as at least one processor that is specialised or advantageously suited for the execution of artificial intelligence. These can be AI specialised system-on-chip solutions, graphical processing units (GPU), neural processing units (NPU), tensor processing units (TPU), AI accelerator cards, AI accelerator chips, or processors with at least one integrated AI acceleration unit. In some embodiments, multiple processors may be connected as an artificial intelligence computing unit. A ‘computing unit for artificial intelligence’ can also be a virtualised ‘computing unit for artificial intelligence’, for example a virtualised network of several ‘computing units for artificial intelligence’. It can also be a physical network of several ‘computing units for artificial intelligence’.

The device according to the invention can be set up in hardware and/or software in the context of the invention. The device preferably comprises at least one processor and is preferably coupled to at least one computing unit for artificial intelligence.

In the context of the invention, ‘input data’ can be understood to mean, for example, data and/or information provided by an intelligent technical system and/or an intelligent device and/or a robot or the like via a control interface. Such data may include, for example, movement, sensor, performance, operational, environmental, communication, protocol, diagnostic, condition, status, usage and/or utilisation data.

In the context of the invention, ‘control instruction’ can be understood to mean an instruction for controlling at least one intelligent technical system and/or at least one robot and/or at least one intelligent device or the like.

In the context of the invention, ‘standby state’ can be understood to mean, for example, a state within a process in which further process steps are not executed until, for example, input data and/or at least one control instruction is provided.

In the context of the invention, ‘control and data specification’ can be understood to mean, for example, a specification of control commands and data, for example in an undefined format, as text or in a specific format, for example in JSON or XML format.

The following description includes examples of embodiments of the methods, devices, systems, techniques and programme sequences incorporating aspects of the disclosure. However, it is to be understood that the present disclosure may be embodied without these specific details. In other instances, known instruction instances, protocols, structures and techniques have not been shown in detail so as not to clutter the description.

The method according to the invention, the device according to the invention and the control system according to the invention include an ability to control intelligent technical systems and/or intelligent devices and/or robots or the like without a request-based provision of data and to determine the control risk prior to control in order to minimise the negative effects of any incorrect control.

The invention relates to a computer-implemented method for controlling at least one intelligent technical system and/or at least one intelligent device and/or at least one robot or the like by means of at least one AI language model, comprising the following procedural steps
Procedural step S1: providing a control and data specification SP1,
Procedural step S2: providing an instruction H and a maximum control risk value D,
Process step S3: providing the control risk context SK,
Process step S4: activating a standby state W and waiting for data, for example for input data ED1 and/or a control instruction S,
Process step S5: generating the control command in dependence on an action instruction H, a control and data specification SP1, a maximum control risk value D, a control risk context SK and input data ED1 with execution-protecting features in order to reduce a negative effect due to a possibly incorrect control, using deep neural networks comprising an AI language model executed at least on an artificial intelligence computing unit,
Process step S6: determining a control risk value of the control command generated in process step S5 as a function of the control risk context SK using a deep neural network comprising an AI language model executed at least on an artificial intelligence computing unit in order to reduce a negative effect due to a possibly incorrect control,
Procedure step S7: Verification whether the determined control risk value of the control command complies with a maximum control risk value D in order to reduce a negative effect of a possibly incorrect control,
Procedure steps S8 and S9: modifying, including iterative modifying, the control command depending on the control risk context SK using deep neural networks comprising an AI language model until the control risk value of the modified control command complies with a maximum control risk value D, in order to reduce a negative effect due to a possibly incorrect control,
Procedure step S10: removing the execution-protecting features of the control command and executing the control,
Procedure step S11: activating the wait state W and waiting for new data, for example for input data ED1 and/or a control instruction S.

In a step S1, a control and data specification SP1 is provided to an AI language model module 104 via an interface 101. The control and data specification SP1 comprises a description of control commands for controlling one or more intelligent technical systems and/or intelligent devices and/, robot or the like, and a description of data that an intelligent technical system and/or intelligent device and/, robot or the like can provide via interface 102. A control and data specification SP1 may, for example, contain a description of control commands that can be executed, for example, at the operating system level.

In some embodiments, the interface 101 can be a computer-implemented interface for providing, for example from a database, an instruction H, a control risk maximum value D, a control and data specification SP1 and a control risk context SK. A computer-implemented interface can, for example, provide data in an unspecified and/or specified format, such as JSON and/or XML format. In some embodiments, for example, the interface 101 can be a chatbot as a web-based or command-line-based application, comprising an input option and an output option.

In some embodiments of the interface 102, data is provided via a computer-implemented interface, for example. A computer-implemented interface can, for example, provide data in a machine-readable format, for example in JSON and/or XML format.

In a step S2 of the procedure, an instruction H and a maximum control risk value D are recorded and provided for the language model via interface 101. This instruction H contains at least one condition described in textual form.

In an S3 step, a risk context SK is provided to the language model module 104 via interface 101. A risk context SK may, for example, contain a description of risk scenarios.

In a step S4, the AI language model module 104 is put into a ready state W. It is ready until data is provided, for example until a control instruction S is provided by a user via interface 103 or input data ED1 is provided via interface 102 by at least one intelligent technical system and/or at least one intelligent device and/or at least one robot or the like.

The process steps S1, S2, S3 and S4 of the process according to the invention can advantageously be combined with each other, for example as a step S12.

In some embodiments, the interface 103 may be a chatbot as a web-based or command-line-based application. In some embodiments, speech recognition may be used as an intermediate step to convert speech into text, for example via a microphone.

In a next step, S5 a control command is generated by the AI language model module 104 after data has been provided, for example input data ED1 via interface 102 and/or a control instruction S via interface 103, wherein the AI language model generates a control command with execution-protecting features depending on an action instruction A, a control and data specification SP1, a maximum control risk value D, a control risk context SK and input data ED1. A control command with execution-protecting features protects against the execution of a control command and reduces the risk of unverified controls in order to reduce negative effects of a possibly incorrect and/or unverified control. In some embodiments, execution-protecting features can be implemented, for example, by a prefix, for example the character #. In some embodiments, execution-protecting features can be implemented, for example, by a prefix and a suffix, for example in a format <<n control command n, where control command is a placeholder for a control command.

In the next step, S6, a testing and improvement module 105 determines the control risk depending on the risk context SK of the generated control command using deep neural networks comprising an AI language model to reduce the negative effects of any incorrect control.

In the next step, S7 verifies whether the determined control risk value complies with a maximum control risk value D. If the determined control risk value complies with a maximum control risk value D the test and improvement module 105 releases the control command for execution by passing the control command without execution-protecting features from step S5 to the execution module 106. If the determined control risk value D] does not comply with a maximum control risk value, the control command is improved in a next step S8 by modification and passed again for verification (S9) in order to reduce a negative effect of a possibly incorrect control.

In a next step S10, a control is executed by the execution module 106. In some embodiments, the execution module 106 may be a computer program product, for example. In some embodiments, a control command may be passed directly to the operating system for execution by an operating system process, for example. In one embodiment, a computer-implemented method is executed to execute a control command. The execution results are logged and the execution log is provided to the AI language model module 104.

In the next step, S11, the waiting state W is activated so that a new control can take place.

In particular, a control command can be adapted by means of an optimisation method, whereby the control command is adapted iteratively and a control risk value is recalculated for an adapted control command until the recalculated control risk value complies with a maximum control risk value D in order to reduce the negative effects of any incorrect control. A control command is not executed if a control risk value does not comply with a maximum control risk value D, in order to minimise the negative effects of any incorrect control.

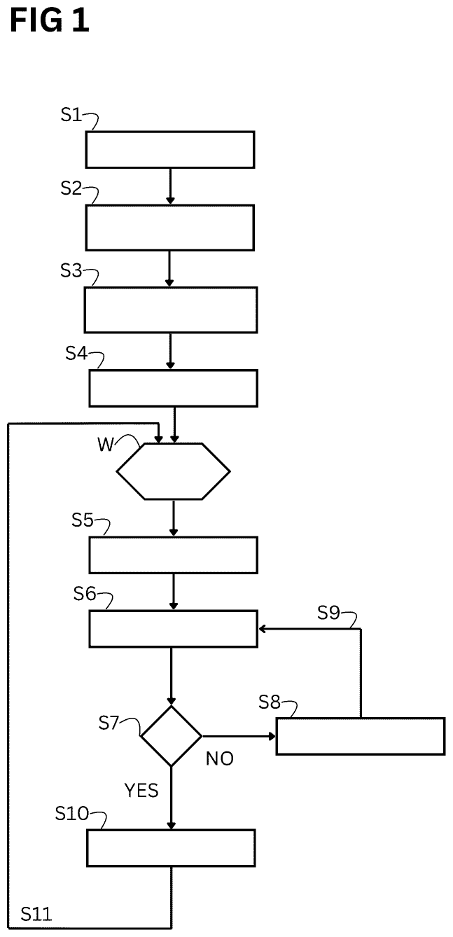

FIG. 1 shows an example of the method according to the invention for controlling intelligent technical systems and/or intelligent devices and/or robots or the like by means of an AI language model as a flow chart. In this example, the method steps of the method according to the invention S1, S2 and S3 are carried out individually. These steps can advantageously be combined with each other.

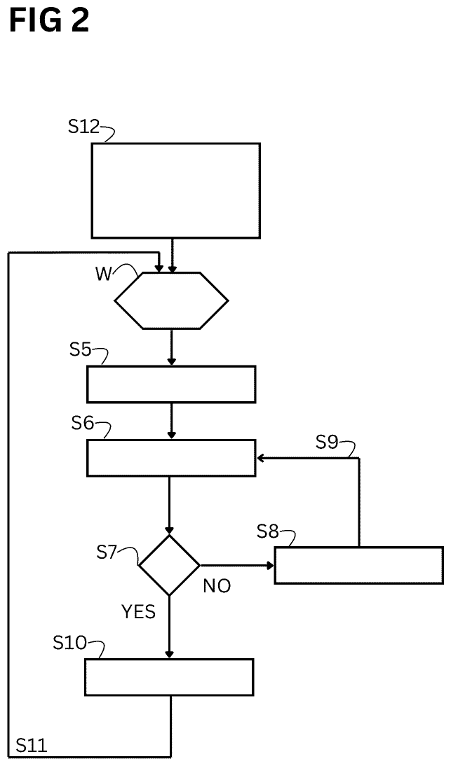

FIG. 2 shows an example of the method according to the invention for controlling intelligent technical systems and/or intelligent devices and/or robots or the like by means of an AI language model as a flow chart. In this example, the method steps of the method according to the invention S1, S2, S3 and S4 are advantageously combined as method step S12. In particular, a control and data specification SP1, an instruction H, a maximum control risk value D, a control risk context SK, for example from a database, can be provided via interface 101 and the waiting state W can be triggered simultaneously by advantageous combination in one step.

In particular, the method according to the invention can be at least partially or even completely computer-aided and/or computer-based and/or computer-implemented. According to the invention, computer-implemented, computer-based or computer-aided can be understood to mean, for example, an implementation of the method in which at least one step of the method is carried out by a processor.

The function of the method according to the invention is significantly determined by the method steps, a set of instructions H, input data ED1, a maximum control risk value D, a control instruction C, a control and data specification SP1 and a control risk context SK. The training procedure or the training data sets of the AI language model are not in themselves of decisive importance for the function of the method according to the invention, nor for the device according to the invention. The training procedure or the training data of the deep neural network with AI language model are therefore not of decisive importance. A person skilled in the art, knowing the process and the device, is particularly aware of how an existing AI language model can be selected or trained. Disclosure of training data and/or the training procedure of the deep neural network with AI language model is not required. Preferably, a deep neural network with AI language model is used that has been trained using current methods, whereby the training data preferably comprises at least 3 billion parameters in textual form and/or literary works. This magnitude proved to be a compromise between a formulation of an instruction H, a maximum control risk value D, a control instruction S, a control and data specification SP1, a control risk context SK and a training size of training data. However, the method and device according to the invention can be carried out with a significantly smaller deep neural network with an AI language model, which has been trained with a significantly smaller training data set. In particular, the function of the method, device and control system according to the invention can also be performed with a smaller amount of training data than preferred if the input parameters ED1, H, D, SP1 and SK are adapted to this amount of training data. Of course, the method and device according to the invention can also be carried out with a deep neural network with an AI language model, which is significantly larger or which has been trained with a significantly larger training data set or training data volume. Deep neural networks with an AI language model that have been trained with larger training data sets allow a more human-readable description of input.

Alternatively, an exemplary data set is disclosed for each of the following: an instruction for action H, a maximum control risk value D, a control and data specification SP1, input data ED1, a control instruction S and a control risk context SK. It goes without saying that this is only an example and is only intended to clarify input parameters, for example. A control and/or data specification SP1 may, for example, contain: “Note the following commands: A lamp is switched on with lamp-on lamp. Where lamp is the lamp. Switching off is done with lamp-off lamp. Waterdamage-detected means that water damage has been detected.”. An action instruction H may, for example, contain: “When I give you the command, switch the lamp on or off. But never switch the lamp on if water damage has previously been reported by the water sensor.”. A control risk context SK can, for example, include: “If water damage has been reported and the lamp is to be switched on, the risk is 100. If there is no water damage, the risk is 10. There is no water damage at present.”. A control risk maximum value D can, for example, contain: “Switch on only if the risk is 50 or less.”. A control instruction S can, for example, contain: “Switch on kitchen lamp”. Input data ED1 can, for example, contain: “Water damage reported”. For this specific example, the device 100 will generate a control command for switching on the kitchen light with execution-protecting features, verify it in dependence on a control risk context SK and, if a control risk maximum value D is adhered to, provide a control command without execution-protecting features of a control interface 107 for execution, which controls.

According to a further aspect, the invention relates to a device 100 for controlling at least one intelligent system (ITS) and/or at least one intelligent device (IG) and/or at least one robot (R) or the like, comprising
a first interface 101 that is set up to read in a control and data specification SP1, an instruction H, a maximum control risk value D and a damage risk context SK
a second interface 102 that is set up to read in input data ED1 from at least one technical system and/or at least one intelligent device and/or at least one robot or the like,
a module 104 comprising a deep neural network with an AI language model that is set up to execute the deep neural network with the AI language model on a computing unit for artificial intelligence, read in data provided via interfaces 101, 102 and 103, exchange data with interface 105, read in data from interface 106, and always provide outputs of the deep neural network with AI language model to the verification and improvement module 105,
a verification and improvement module 105 that is set up to generate a control risk value for a generated control command using at least one deep neural network comprising an AI language model executed on a computing unit for artificial intelligence as a function of a control risk context SK and to compare the determined value with a maximum control risk value D, outputting a test result with a control command, cancelling a control or iteratively improving the control command until a maximum control risk value D is complied with, in order to reduce negative effects of a possibly incorrect control,
an execution module 106 that is set up to read in and execute at least one generated and tested control command, for example at the operating system level.

In some embodiments, the AI language model module 104 can advantageously store the provided data in a history via interface 101 and/or 102 and/or 103. In some embodiments, the history can be restricted or structured. For example, the module 104 can store the last 50 control instructions. A history can be stored in a database, for example.

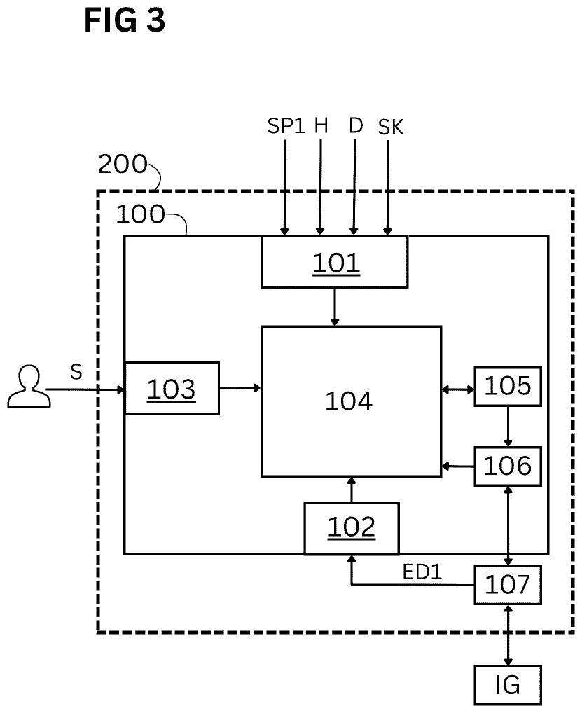

FIG. 3 shows an example of the device according to the invention for controlling at least one intelligent device (IG).

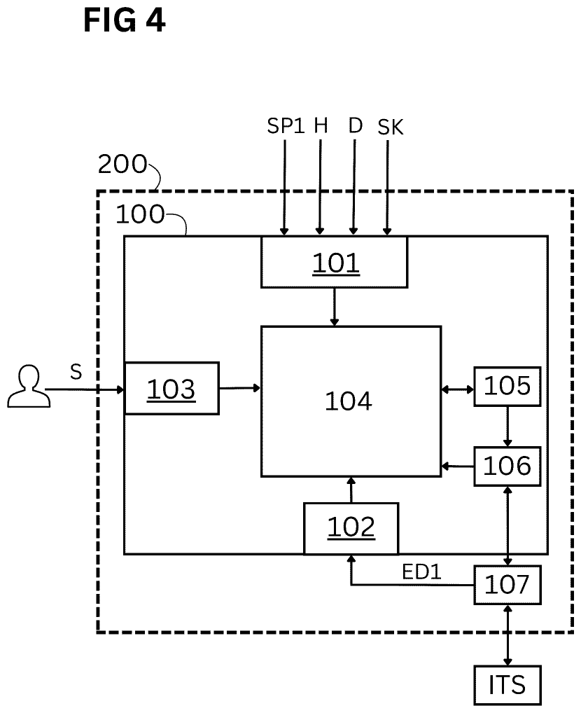

FIG. 4 shows an example of the device according to the invention for controlling at least one intelligent technical system (ITS).

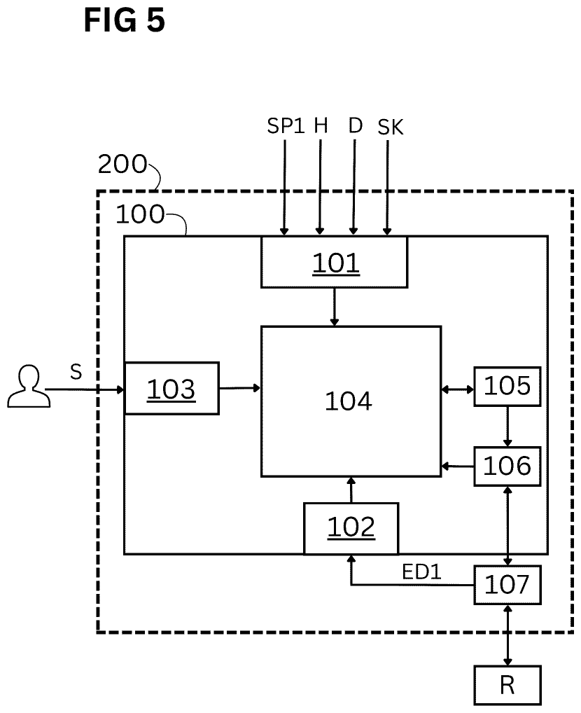

FIG. 5 shows an example of the device according to the invention for controlling at least one robot (R) or the like.

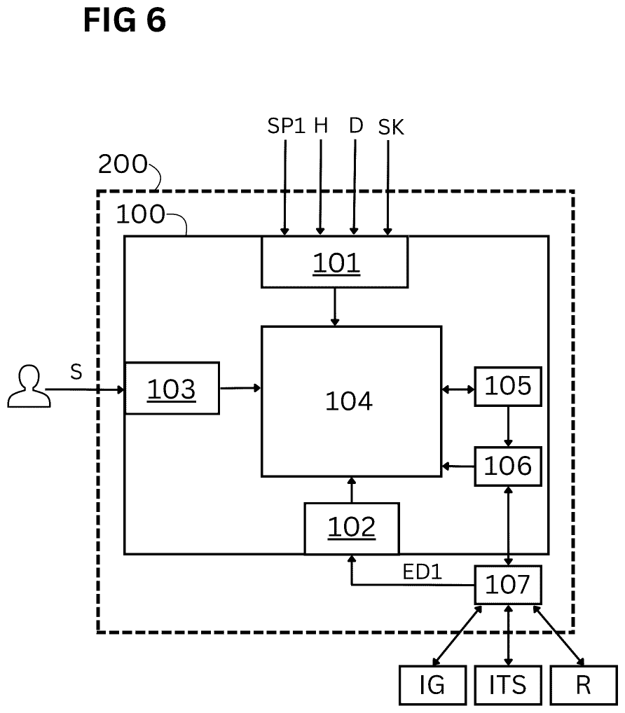

FIG. 6 shows an example of the device according to the invention, with at least one control interface for controlling intelligent devices (IG) and/or at least one intelligent technical system (ITS), and/or at least one robot (R) or the like.

The device and/or at least one of its interfaces or modules can be set up in particular in hardware and/or software. As shown in FIG. 3, the device 100 is preferably coupled to a module 104, which is set up to execute an AI language model on an artificial intelligence processing unit, an execution module 106 and a testing and improvement module 105, wherein the device is set up to generate a control command based on an AI language model and to provide it to a control unit or control interface 107.

The device 100 is configured in such a way that outputs of the AI language model module 104 are always provided to the verification and improving module 105. The verification and improving module 105 is configured in such a way that it determines a control risk value for generated control commands and compares the determined control risk value with a maximum control risk value D.

In one embodiment, the function of the test and improvement module 105 can be implemented, for example, in two separate modules that are set up to first test a control command and then iteratively modify it until the determined control risk value of the control command complies with a maximum control risk value D.

According to a second aspect, the invention relates to a control system 200 for controlling at least one intelligent system (ITS) and/or at least one intelligent device (IG) and/or at least one robot (R) or the like, comprising
at least one control interface 107 that is designed to control intelligent devices (IG) and/or intelligent technical systems (ITS) and/or robots (R) or the like and to provide control protocols to the execution module 106 within the device 100,
at least one integrated artificial intelligence computing unit,

‘Control interface’ can mean a combination of hardware and/or software that can communicate with intelligent devices (ID) and/or intelligent technical systems (ITS) and/or robots (R) or the like in order to control them, whereby control is via a physical, optical or wireless interface, e.g. a USB interface, a fibre optic connection, a LAN connection, an energy-saving wide-area radio, a short-range radio, a low-energy radio, Bluetooth Low Energy, LPWAN technology, cordless communication, energy-saving cordless communication, short-range radio, wireless mesh network for home automation, wireless LAN, Ethernet, communication protocol for energy management, powerline communication technology, KNX, serial peripheral interfaces, CAN bus, radio-based automation system, industrial bus systems, IP-based home automation system radio, or a potential-free contact. In some embodiments, it may include a computer program product, for example a driver.

Furthermore, the invention relates to a computer program product that can be loaded directly into a programmable computer, comprising program code parts that, when the program is executed by a computer, cause the computer to carry out the steps of a method according to the invention.

For example, a computer program product may be provided on a storage medium, such as a solid state disk, non-volatile memory, eMMC, UFS, ROM, EEPROM, virtual memory, a hard disk, memory cards or even in the form of a downloadable file from a service.

A person skilled in the art is particularly familiar with knowledge of the process claim(s) in the prior art, and all the usual possibilities for realising the invention are self-evident to him. Therefore, there is no need for a separate disclosure in the description.

All the features described and/or shown in the drawings can be advantageously combined with each other in the context of the invention.

All the preceding descriptions and accompanying drawings are not intended to describe or illustrate every embodiment or implementation. The invention is not limited to the embodiments or implementations described or illustrated.

1. A computer-implemented method for controlling intelligent devices (IG), intelligent technical systems (ITS), robots (R) or the like, comprising the following steps:
reading in (S1) a control and data specification (SP1); reading in (S2) of an instruction (H) and a control risk maximum value (D); reading in (S3) a control risk context (SK);
activating (S4) the standby state (W) and waiting in the standby state (W) for input data (ED1) containing at least one data record provided by at least one intelligent device (IG), intelligent technical system (ITS), robot (R) or the like;
generating (S5) a control command with execution-protecting features as a function of the provided input data (ED1), an instruction (H), a control and data specification (SP1), a maximum control risk value (D) and a control risk context (SK) using an SLM, in order to reduce negative effects and/or risks of a possibly defective, incorrect, incomplete, unintended or only partial control;
determining (S6) a control risk value of a control command without execution-protecting features as a function of the provided input data (ED1), an instruction (H), a control and data specification (SP1), a maximum control risk value (D), a control risk context (SK) using an SLM, in order to reduce negative effects and/or risks of a possibly defective, incorrect, incomplete, unintended or only partial control;
verification (S7) whether the control risk value complies with a control risk maximum value (D), and continue the procedure if the result is positive, otherwise do not execute control, in order to reduce negative effects and/or risks of a possibly faulty, incorrect, incomplete, unintended or only partial control and output of a verification result;
execution (S10) of the control command, after removal of execution-protecting features;
wait (S11) in standby state (W).

2. A computer-implemented method for controlling intelligent devices (IG), intelligent technical systems (ITS), robots (R) or the like according to one of the preceding claims, wherein the control risk value of the control command is reduced by modifying the control command (S8) in order to minimise negative effects and/or risks of a possibly defective, incorrect, incomplete, unintended or only partial control.

3. A computer-implemented method for controlling intelligent devices (IG), intelligent technical systems (ITS), robots (R) or the like according to one of the preceding claims, wherein the control command is iteratively modified (S9) until the determined control risk value of the control command complies with a maximum control risk value (D) in order to reduce negative effects and/or risks of possibly faulty, incorrect, incomplete, unintended or only partial control.

4. A computer-implemented method for controlling intelligent devices (IG), intelligent technical systems (ITS), robots (R) or the like according to one of the preceding claims, wherein the method steps S1, S2, S3 and S4 are carried out in combination in a single step (S12).

5. A computer-implemented method for controlling intelligent devices (IG), intelligent technical systems (ITS), robots (R) or the like according to one of the preceding claims, wherein the method steps S5, S6 and S7 are carried out in combination.

6. A computer-implemented method for controlling intelligent devices (IG), intelligent technical systems (ITS), robots (R) or the like according to one of the preceding claims, wherein a large AI language model or LLM is used when generating (S5) the control command and when determining (S6) the control risk.

7. A computer-implemented method for controlling intelligent devices (IG), intelligent technical systems (ITS), robots (R) or the like according to claim 1, wherein the control command is provided directly by the execution module (106) to the operating system for execution and the execution is started.

8. A device (100) for controlling intelligent devices (IG), intelligent technical systems (ITS), robots (R) or the like, comprising:
a first interface (101) that is set up to read in a control and data specification (SP1), an instruction (H), a maximum control risk value (D) and a control risk context (SK);
a second interface (102) that is set up to read in input data (ED1) provided by intelligent devices (IG), intelligent technical systems (ITS), robots (R) or the like via a control interface;
a third interface (103) that is set up to read in a control instruction(S);
an AI language model module (104) which is set up to execute a deep neural network comprising a small AI language model or SLM on an artificial intelligence processing unit in order to reduce the technical system requirements, to generate control commands as a function of input data (ED1), a control and data specification (SP1), a set of instructions (H), a maximum control risk value (D), a control risk context (SK), and to provide generated data to a test and improvement module (105);
a verification and improvement module (105) which is set up to read in outputs of the AI language model module (104), to determine a control risk value for executing the control command as a function of the control risk context (SK), to compare the determined control risk value with a maximum control risk value (D), to modify a control command iteratively by modification in order to reduce the control risk value until it complies with a maximum control risk value (D), in order to reduce negative effects and/or risks of a possibly defective, incorrect, incomplete, unintended or only partial control, to provide and output a test result; and,
an execution module (106) that is set up to read a generated control command, to execute it on the operating system and/or to provide it to the control interface (107), to read the output after the execution and/or provision, for example control protocols.

9. A device according to claim 7, wherein the interfaces 101 and 102 are combined into one interface.

10. A control system (200) for controlling intelligent devices (IG), intelligent technical systems (ITS), robots (R) or the like, comprising:
a device (100) according to one of claims 8 to 9;
at least one artificial intelligence processing unit arranged to carry out an artificial intelligence with a deep neural network comprising an AI language model;
at least one control interface for controlling intelligent devices (IG); intelligent systems (ITS), robots (R) or the like, which is configured to control them and to provide device data or input data (ED1) of the interface 102 within the device (100).

11. An intelligent device (IG), intelligent technical system (ITS), robot (R) or the like, which has a device (100) according to one of claims 8 to 9 and/or can be controlled by a method according to one of claims 1 to 7 and/or has a control system (200) according to claim 10.

12. A computer program product loadable into a computer, comprising program code suitable for carrying out the method steps of the method according to one of the claims 1 to 7.
